(19) United States
(12) Patent Application Publication
(10) Pub. No.: US 2012/0199064 A1
(43) Pub. Date: Aug. 9, 2012

(54) Fluid Dispensing Device

(76) Inventor: Eric Scot Foy, Medford, OR (US)

(21) Appl. No.: 13/367,383

(22) Filed: Feb. 7, 2012

Related U.S. Application Data
(60) Provisional application No. 61/440,334, filed on Feb. 7, 2011.

(51) Int. Cl. B05C 11/00; B67D 3/00; B05C 5/00; B67D 7/08

(52) U.S. Cl. 118/674; 222/559; 118/300; 239/71

(57) ABSTRACT

A fluid delivery device wherein the traditional quasi-planar doors or gates are replaced by one or more plugs of approximately inverted teardrop cross sectional shape. Said plugs rest and bear against a sealing surface to effect sealing of the tank shut, and are actuated in a direction contrary to the direction of fluid outflow, into the interior cavity of the tank or hopper plenum in order to effect opening and dispensing of the contained fluid. Exit flow is markedly more laminar and uniform that that attainable with conventional quasi-planar door or gate systems, providing an improved exit flow characteristic, and greater accuracy in placing the working fluid onto a target.

### CROSS-REFERENCE TO RELATED APPLICATIONS

This application claims the benefit of provisional patent application Ser. No. 61/440,334 filed 2011 Feb. 7 by the present inventor.

### FEDERALLY SPONSORED RESEARCH OR DEVELOPMENT

Not Applicable

### SEQUENCE LISTING OR COMPUTER PROGRAM

Not Applicable

### TECHNICAL FIELD

The present invention relates to a device for dispensing a working fluid onto a target surface. Said working fluid may be any one of the following:
(a) liquids,
(b) slurries,
(c) powdered, pelletized or granulated solid substances exhibiting fluid-like bulk flow characteristics.

The present invention finds application in, but is not limited to, the fields of agriculture, construction, roadway maintenance, paper or film processing, material handling, and aerial fire fighting.

### BACKGROUND ART

There exist many instances in various industries wherein the application of a controlled amount of a working fluid onto a target surface is required. Various means of said application have been employed, such as spraying, dumping, or spreading using a spreader, which mechanically throws the working fluid material onto the target surface. In practice, obtaining an even, consistent, and controllable coverage density is of primary operational concern.

### Roadway Maintenance

U.S. Pat. No. 1,863,968 to C. W. Dearing (1932) and U.S. Pat. No. 4,387,855 to Nielson, et al. (1983), both describe a spreader for dispensing granulated substances behind a moving vehicle for the purpose of controlled dispensing of said substance onto the roadway. While these and similar systems may work well for dispensing granulated material of a given minimum granule size, they generally are not suitable for dispensing liquids or slurries due to the difficulty in sealing the various moving members shut to prevent leaking of the working fluid when no outflow is desired.

### Agriculture

U.S. Pat. No. 4,052,003 to Steffen (1977) and U.S. Pat. No. 4,350,293 to Lestradet (1982), disclose systems for controlling the dispensed density of a liquid working fluid such as insecticide or fertilizer. Said prior art describes the use of a plurality of nozzles fed by a pump through a system of piping. Desired dispensing of the working fluid is controlled either by varying the pump output pressure or by switching nozzles on or off. While pressurized nozzle systems hold certain clear advantages for spreading of liquids, they nonetheless have the disadvantage of requiring filtration of the working fluid, and periodic maintenance and down time due to clogged or damaged nozzles, pumps and valves.

### Thin Film Application

There are many industrial processes in which it is desirable to apply a thin film of liquid or particulate to a substrate such as paper, plastic film, plywood laminate, etc. One typical approach involves spraying a finely atomized mist of the working fluid. The fluid must then “wet out” into a contiguous thin layer, such as when spray-painting with the goal of achieving a glossy coating. Much effort has gone into the processing and treatment of said working fluids to enhance their wetting properties. This approach further requires careful attention to and control of many operational parameters such as temperature, humidity etc.

U.S. Pat. No. 7,211,297 to Damrau (2007) and U.S. Pat. No. 5,735,957 to Becker, et al. (1998) both disclose an applicator of thin films onto a film substrate. This approach requires strict dimensional control of the separation distance of the dispensing device from that of the substrate (the target) to which the fluid film is being applied. These kinds of mechanisms can be expensive to build and maintain.

### Material Handling

In handling of bulk liquid or granulate materials, said materials are commonly conveyed from one container to another. A common step in said conveyance is the draining from one tank or hopper to another container located lower in elevation than the first, as in draining a hopper or, e.g., a rail car or truck tank or container. U.S. Pat. No. 898,689 to Sawyer (1908), and U.S. Pat. No. 3,405,656 to Dorey (1968) both disclose approaches to how to control the outflow of working material from the bottom of a gravity-fed hopper. Whereas these embodiments work acceptably for granulate or pelletized working fluids, they fail to provide a means of sealing the hopper or tank shut for the application of their use to a liquid or slurry, without exceptional precision in fabrication and the application of wiping seals, which in practice have proven a formidable obstacle to both design and fabrication.

### Aerial Fire Fighting

Modern aerial fire fighting systems typically comprise a tank or plurality of tanks mounted inside an aircraft or attached externally to the underside of the aircraft fuselage. Early developments in the field employed only gravity to facilitate the exit of the working fluid from the tank or tanks. Said working fluid is normally either water or a fire retardant slurry. Some more recently developed systems use a compressed gas such as air to force the retardant out of the tanks, as well as to facilitate transfer of the fluid from the storage tanks to the final exit nozzle. Today many examples of both methods remain in service.

Compressed gas evacuation systems such as that disclosed in U.S. Pat. No. 7,165,627 to Hutter, et al. (2007), have the advantage of requiring less area for the final exit aperture, though they have the disadvantages of added complexity and increased overall system weight. Furthermore, due to their reduced exit area, a higher exit velocity of the working fluid is required in order to achieve the required drop density, resulting in turbulence in the exit flow, which in turn results in an undesirable level of dispersion in the exit flow, thus degrading their ability to place a concentrated drop onto the target.

The ultimate goal in aerial fire suppression is the accurate placement of the working fluid onto the target. To this end, the drop pattern is of utmost importance. The drop pattern is defined and quantitatively measured in a test situation by overflying a grid of cups and performing a drop. The cups are then each weighed in order to determine the spatial dispersion of the working fluid as it arrives on the ground. Determining factors include aircraft flight velocity, aircraft altitude above ground level, and the exit flow characteristics of the working fluid leaving the aircraft.

Various methods have been employed to augment the exit flow characteristics of gravity-fed tank systems, such as those shown in U.S. Pat. No. 3,901,467 to Hawkshaw (1975), and U.S. Pat. No. 4,671,472 to Hawkshaw (1987). The main problems to exit flow control in current systems stem primarily from the fact that current and traditional systems use one or more hinged doors of quasi-planar shape to regulate outflow.

In the case of a single door which is hinged along the flight-wise axis, the working fluid outflow at partial opening is deflected asymmetrically as it flows through the outlet. If the door is instead hinged along the transverse axis (perpendicular to the direction of flight), then excessive door width is required to obtain an adequate exit area. Furthermore, a partially open quasi-planar door presents an inherently unfavorable flow path for the exiting fluid, which generates turbulence in the exit flow field.

U.S. Pat. No. 4,936,389 to MacDonald, et al. (1990) discloses two doors side by side, hinged along the flight-wise axis. In this configuration the exit flow is disturbed by an intervening structural element and sealing surfaces which bisect the field of fluid flow, resulting in turbulence within the exit flow field of the working fluid. This turbulence leads to a premature break-up and dispersion of the working fluid, in turn requiring a lower flight altitude in order to accomplish a concentrated drop pattern onto the target. Lower flight altitudes result in higher horizontal velocity of the fluid as it contacts the ground, which has caused damage to both forest and man-made structures, and presents a hazard to ground personnel who may be present in the drop zone.

Systems have been built and tested by the present inventor wherein the doors, hinged from their outboard edges, seal against each other at the center line, thus eliminating the need for the aforementioned intervening structural element or sealing surfaces. These systems have proven to be problematic as the seal is very difficult to maintain in field conditions.

### SUMMARY OF INVENTION

The present invention is a fluid dispensing device comprising one or more specially shaped plugs to regulate the outflow of the working fluid through one or more exit apertures which are of complementary shape to said plug or plugs. Said plug or plugs functionally replace the quasi-planar doors or gates commonly used in fluid dispensing devices and spreaders. The present invention is applicable to both gravity-fed systems and to compressed gas or pressurized fluid delivery systems such as previously discussed.

### Technical Problem

Problems associated with the current state of the art include the following:
(a) Inability of granulate or pellet spreaders to adequately seal off the outflow to be used in the application of liquids or slurries;
(b) requirement of careful filtering of the working fluid in order to prevent clogging of nozzles and/or damage to pumps;
(c) turbulence in the working fluid outflow, which results in diffusion of the dispensed material, particularly during cracking (initial opening) and closing, as well as at lower than full flow rates;
(d) highly diffused outflow at partial opening of quasi-planar doors.
(e) difficulty in metering of flow, especially at low flow rates.

### Solution to Problem

The present invention provides the solution to the problem of providing a favorably contoured flow path for the working fluid at all flow rates of said working fluid. It is known in fluid dynamics that turbulence in a fluid flow develops over a history of flow adjacent to a stationary bounding surface, and that said development of turbulence is accelerated (occurs within a shorter flow history) if said bounding surface is rough or comprises discontinuities in its profile. The present invention solves the problem of turbulence by providing a short flow history in combination with a fair (smooth in the flow-wise direction) adjacent bounding surface of the flow.

The present invention also has the advantage of providing geometrically similar flow paths at all flow rates. That is, whether the device is wide open for maximum flow, just cracked open for minimum flow rate, or at any position between said extremes, the outflow of the working fluid traverses geometrically similar flow paths, providing substantially laminar outflow at all settings.

The present invention also simplifies fluid handling systems by providing both a means of flow metering and a means of flow contouring. The present invention can be characterized as either a valve, a nozzle, or both.

### Advantageous Effects of Invention

Several objects and advantages of the present invention are:
(a) to provide a means of dispensing a working fluid onto a target surface in a controlled manner, said working fluid being any of
   1. liquid, such as water, fertilizer, insecticide, oil, tar, and others;
   2. slurry, such as fire retardant, mud, concrete cement and others;
   3. granular or pelletized solids, either wet or dry, having fluid-like bulk flow characteristics;
(b) to provide a fluid dispensing means which does not have a tendency to develop leaks at the sealing surfaces, thus requiring less periodic or preventive maintenance toward that end;
(c) to provide a laminar flow characteristic in the working fluid exiting the tank or hopper at all flow rates;
(d) to provide a means of dispensing a working fluid from a tank or hopper, with close and accurate control of flow rate and total amount dispensed, and with well formed flow characteristics, particularly at cracking (opening), low flow rates, and at shutoff.
(e) To provide a means of applying a thin film of fluid to a substrate without requiring close dimensional control of the separation distance between the substrate and the dispensing device;
(f) To provide a fluid dispensing means wherein the metering valve and the exit nozzle are one and the same mechanical embodiment.

Particularly in the field of aerial fluid application, the advantages of the present invention include, without limitation, the following:
(g) Better exit flow characteristics: The hydrodynamic cleanness of the flow path facilitates a more laminar flow than is possible with any systems of the current state of the art. This has a direct relationship to the resultant drop pattern, providing improved drop control.
(h) Increased safety: aircraft using the current invention will be able to drop from a higher altitude above the ground compared with other aircraft using systems of the current state of the art. This results in an increased margin of safety for airmen and ground crews alike.
(i) Flow regulation: Utilizing modern commercially available control technology, very fast-reacting servo control systems are available. Since exit flow rate is directly proportional to the vertical position of the plug, the current invention makes better use of this technology by presenting a physical model whereby logical electronic input is more readily translated into physical, actual regulation of fluid flow.

### BRIEF DESCRIPTION OF DRAWINGS

FIG. 1 is a perspective view of a typical installation of the present invention, viewed from slightly above the seal plane;

FIG. 2 is a perspective view of the typical installation of FIG. 1, but viewed from slightly below the seal plane;

FIG. 3 is a cross sectional view, the section cut as indicated in FIG. 1, showing the device in the closed position;

FIG. 4 is a cross sectional view, the same section as in FIG. 3, showing the device in the open position;

FIG. 5 is a cross sectional view, the same section as in FIG. 3, illustrating the fluid exit path with the device in a partially open position;

FIG. 6 is a cross sectional view, the same section as in FIG. 3, illustrating the fluid exit path with the device in a near fully open position;

FIG. 7 is a side view of plug assembly 20;

FIG. 8 is an end view of plug assembly 20;

FIG. 9 is an inverted perspective view of plug assembly 20;

FIG. 10 is an inverted perspective view of an alternate embodiment of the present invention;

FIG. 11 is an inverted perspective view of an alternate embodiment of the present invention;

FIG. 12 is a perspective view of an alternate embodiment of the present invention as applied to a truck for application of the working fluid onto the ground.

FIG. 13 is a close up view of the embodiment of FIG. 12

FIG. 14 is an elevation view of the embodiment of FIG. 12

FIG. 15 is a cross sectional view of the embodiment of FIG. 12 showing a possible linkage detail in the closed position.

FIG. 16 is a cross sectional view of the embodiment of FIG. 12 showing a possible linkage detail in the open position.

### DESCRIPTION OF EMBODIMENTS

### FIGS. 1 through 9

### Preferred Embodiment

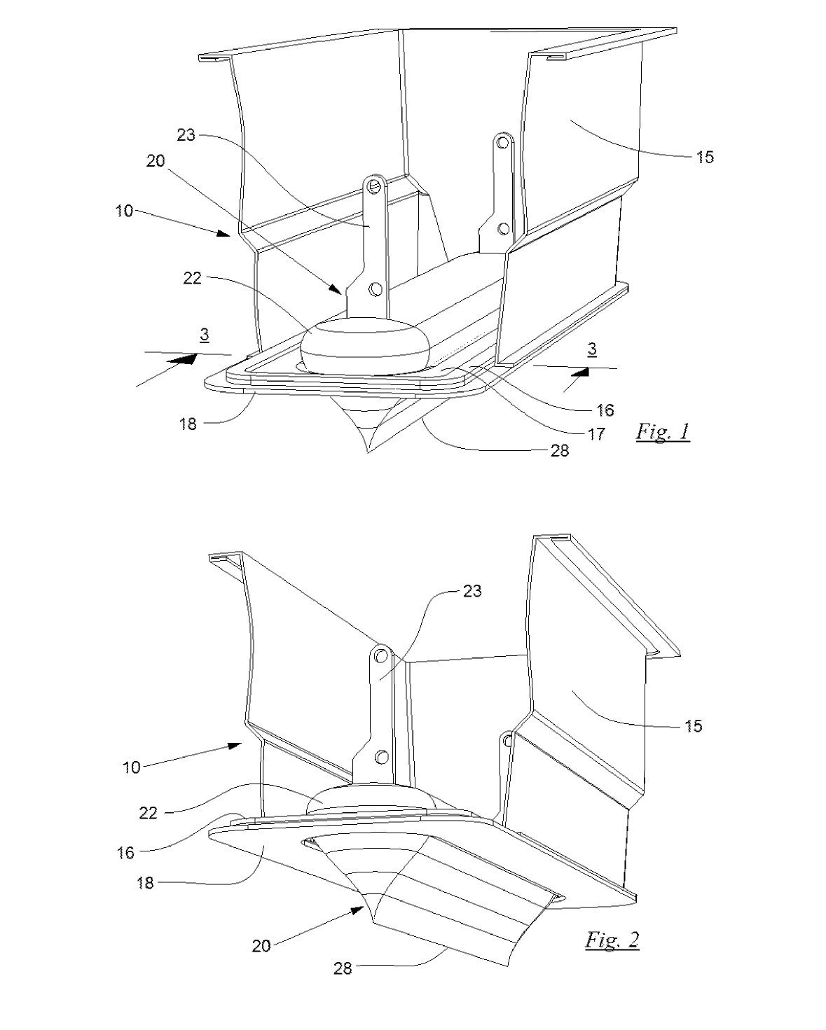

Referring now to the invention in more detail, in FIGS. 1 and 2, there is shown a tank assembly 10 having a plenum region enclosed by a tank shell 15 shown for sake of illustration in a typical application, and lower floor plate 18. The tank shell 15 is shown in cutaway form in FIGS. 1 and 2 to allow visibility of the rest of the assembly. Attached to said floor plate 18 is a seal diaphragm 17 which is fixably retained and held in position by clamp bezel 16. Tank assembly 10 further comprises plug assembly 20, which in turn comprises (a) plug body 22 having an inverted teardrop-like cross sectional shape with a bluff upper surface, tapered side flanks and a sharp trailing edge 28 at its lower extremum, and (b) a plurality of actuation brackets 23 of arbitrary shape, each fixably attached to the plug body 22. In a real mechanical embodiment disclosed subsequently herein, actuation brackets 23 would attach to an actuation mechanism whereby the plug assembly's 20 motion relative to the rest of the tank assembly 10 is constrained to approximately vertical motion only. This can be attained through a variety of means commonly known in the art, and thus is not germane to the current discussion. Note that exactly vertical motion is not a requirement, therefore any of a variety of mechanical linkage schemes may be used for guidance of the plug body 22.

In more detail, still referring to the invention of FIGS. 1 and 2, the vertical motion of the plug assembly 20 is restricted in the downward direction by the fact that the width and length dimensions of the plug body 22 are sufficiently larger than the opening in the seal diaphragm 17 and the floor plate 18 so as to prevent the plug body 22 from passing through said opening. Sealing of the fluid in the tank is aided by the pressure of the fluid contained in the tank bearing downward upon the plug body 22, and forcing it against the seal diaphragm 17. The action is analogous to a cork or rubber stopper in the bottom of a tank of water, placed in its hole from inside the container.

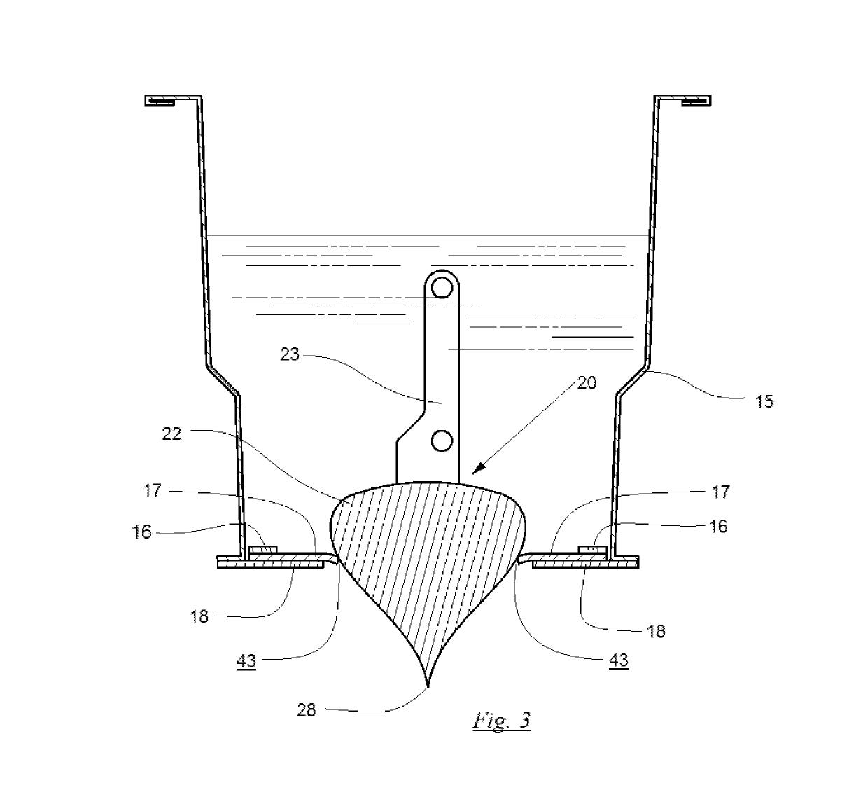

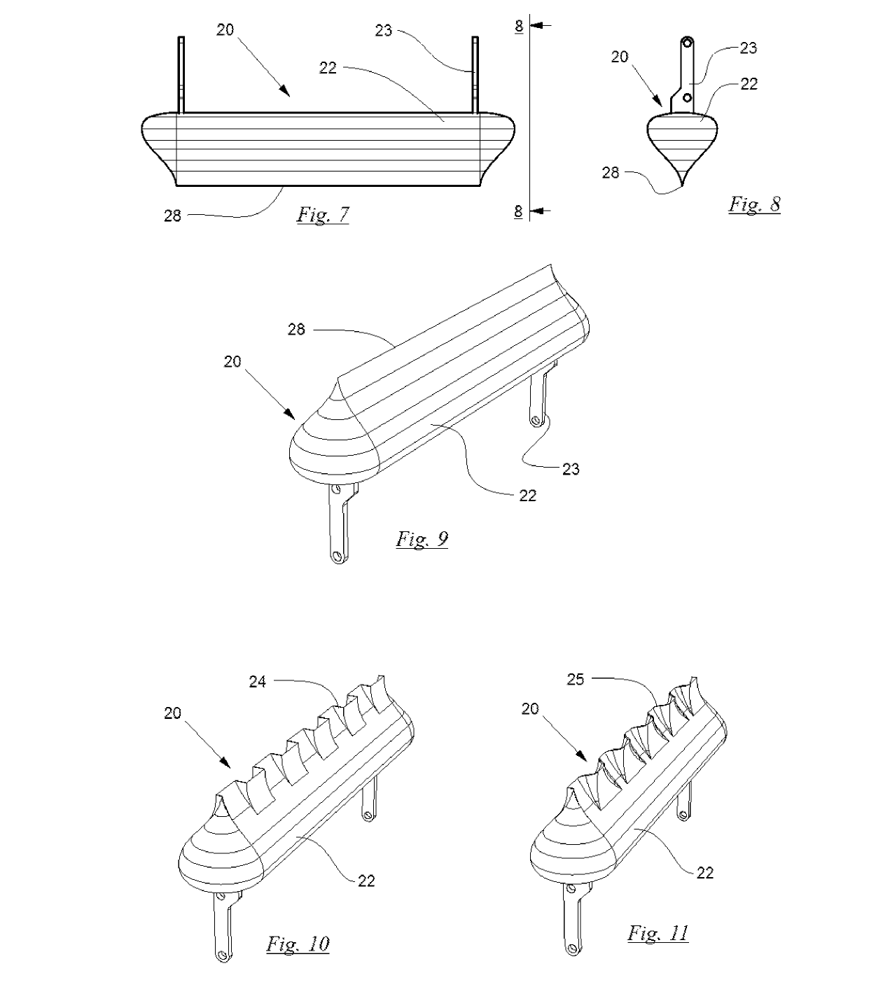

Referring now to FIG. 7, the plug assembly 20 is shown in a side view. FIG. 8 is an end-wise view of plug assembly 20. The plug body 22 is shaped such that any horizontal cross sectional slice taken will describe an oval perimeter having parallel sides and full radius ends, each said end describing a half circle. Thus the seal diaphragm 17 of FIGS. 1 through 4 has a complimentary shaped hole cut out, such that every point along the perimeter of said cutout hole mates or collides simultaneously with the flanks of the plug body 22 as the latter is lowered vertically to its shutoff position, thus creating pinch point 43, as shown in FIG. 3. It should be noted that this particular embodiment is only one of many anticipated variations, as in practice the profile of plug body 22 and the shape of the cutout in the seal diaphragm 17 may be crafted to any pair of complementary shapes which would accomplish shut-off of the working fluid.

In further detail, referring to FIG. 3, in the closed position, the plug body 22 is forced downward to a position of interference with the seal diaphragm 17. This interference creates pinch point 43, effectively shutting off the flow of fluid out the bottom of the tank plenum. The required downward force may be provided by the actuation mechanism, by gravity, by fluid pressure forces, or any combination thereof. Dispensing of the fluid contained in the tank is accomplished by upward vertical or nearly vertical actuation of the plug assembly 20. As mentioned previously, said actuation may be accomplished by a number of means common in the art, such as by a rotary shaft and bell crank linkage system, or by direct electric, hydraulic, or pneumatic linear actuation, etc.

Referring now to FIG. 4, as the plug assembly 20 rises vertically, a clearance aperture 42 develops between the lateral flanks of the plug body 22 and the mating edge of the seal diaphragm 17 as a result of the generally tapered shape of the plug body 22. Said clearance presents a flow path for the fluid to exit the tank plenum in the downward direction. The inception of this exit flow is motivated by gravity or additionally by the employment of compressed air or gas over the fluid load, or by direct pressurizing of the working fluid via a pump or compressor to assist in motivating the fluid flow.

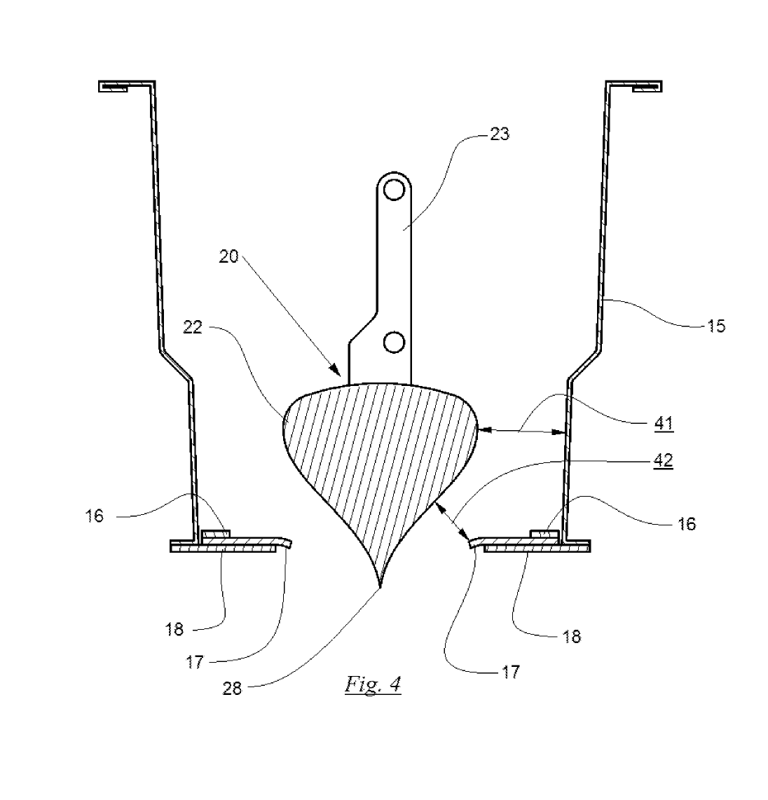

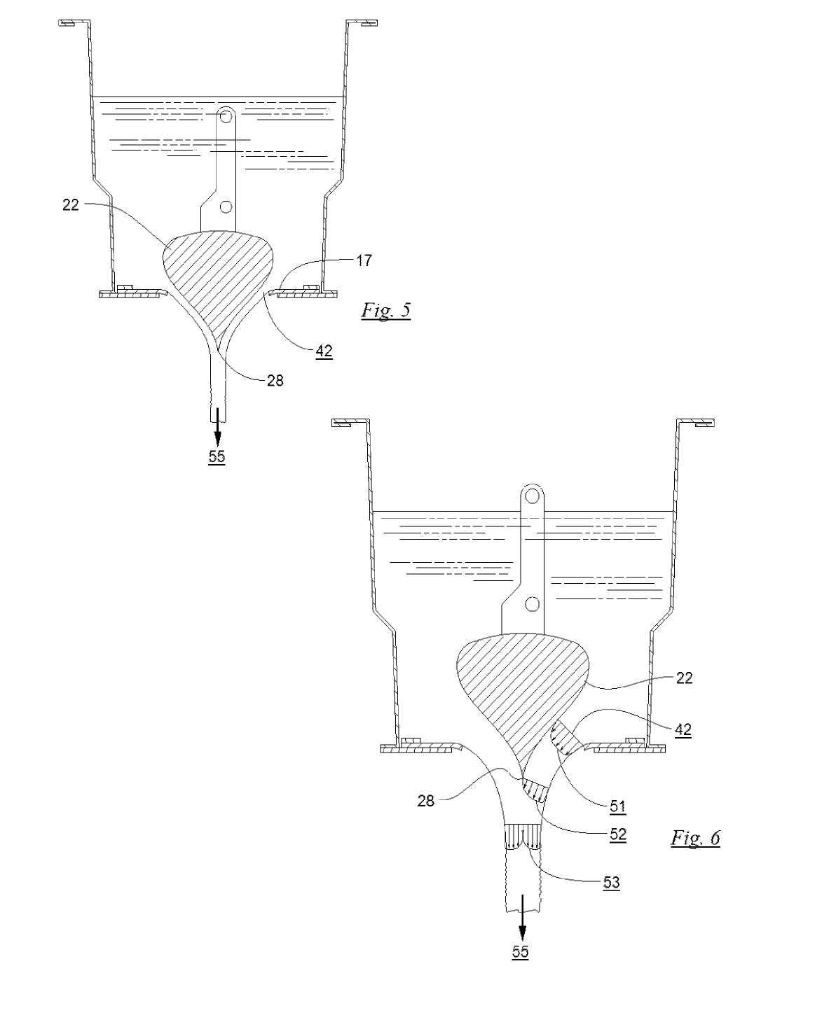

In further detail, referring now to FIG. 5, when the plug body 22 is lifted slightly to a partially open position the fluid exiting the clearance aperture 42 adheres to the flank of the plug body 22, while breaking away from the upper surface of the seal diaphragm 17. In fluid dynamics terminology, the seal diaphragm 17 essentially acts as a sluice gate in relation to the downstream open channel flow along the flank of the plug body 22. Flows from opposite sides meet at the trailing edge 28 of the plug body 22, where said flows converge and combine, having a resultant bulk velocity vector 55 pointing vertically downward.

Referring now to FIG. 6 in further detail, the flow field immediately at the clearance aperture 42 has a velocity profile 51 of approximately half-ellipsoidal shape. This is due to the fact that the stream lines near the surface of the plug body 22 have a flow history which leads to the development of a boundary layer, whereas the streamlines near the seal diaphragm 17 have nearly no flow history which would contribute to the development of a boundary layer. Hence the velocity of the free surface fluid at the outer extreme of the flow channel is nearly equal to the bulk potential velocity of the flow channel at large. By the time the flow has reached the trailing edge 28 of the plug body 22, the boundary layer has developed further, resulting in a more semi-ellipsoidal velocity profile 52. At this point the two flow channels from opposite sides of the plug body 22 meet and converge. Since neither of the two converging flows contain significant turbulence, they combine smoothly, with the resultant downstream velocity profile 53. It is known in fluid dynamics that a free stream flow having velocity profile 53 will remain laminar more persistently than that produced by a standard nozzle exit flow.

### Dimensional Considerations

In further detail, referring to the invention of FIGS. 1 and 2, The plug body 22, floor plate 18 and seal diaphragm 17 are sized such that at full open position the exit flow rate is adequate to provide a salvo drop of all fluid contained in the tank within the time prescribed by convention within the art and practice of the industry in which the invention is applied. In the case of aerial fire fighting, this equals four to eight seconds. Experimentation has demonstrated that a typical 2,000 gallon (15,141 liter) tank can be emptied of water in this time through a single-plug embodiment of this invention wherein the length of the plug is 72 inches (183 cm), its width being 20 inches (51 cm). Total vertical travel of the plug body 22 must be approximately 11 inches (28 cm) to accomplish this.

Referring again to FIG. 4, it is important that the tank shell 15 be sized so that the lateral clearance 41 is greater than the exit clearance aperture 42 at the full open position. This is so that the fluid always reaches maximum flow velocity at the exit aperture 42.

### Construction Details

The construction details of the invention are that the tank shell 15 may be made of any material suitable for the task, such as aluminum, steel, or composites (carbon fiber, glass fiber, etc.). Such materials and methods are well known in the art. The plug may be made of any material with sufficient structural characteristics to withstand the loads applied, which include flexural bending loads imposed by the combination of fluid pressure and lifting force imposed by the actuation mechanism. Materials must be adequately resistant to corrosion and fluid attack, depending on the chemical composition of the anticipated working fluid. Examples include aluminum, steel, and composites. Depending on the desired flow characteristics of the exiting fluid, the shape and fairness of the plug body 22 may be crucial to its operation, and it must resist chafing wear at points of contact with the seal diaphragm 17. Furthermore, the trailing edge 28 of the plug body 22 must be durable enough to remain sharp, and/or it must be protected from collision with foreign objects such as ground handling equipment when in service. The seal diaphragm 17 may be made of any suitable elastomeric material such as rubber or polyurethane. It should be tough enough to resist erosion, yet flexible enough to achieve an adequate seal. In certain cases, such as when the working fluid is non-liquid, the seal diaphragm 17 may be made of a hard material such as steel, aluminum, high durometer elastomer, phenolic composite, etc.

### FIGS. 10 and 11

### Alternate Embodiment

Referring now to the invention shown in FIGS. 10 and 11, in some cases it may be desirable to produce a less laminar flow, or to induce turbulence to the exit flow stream. In such a case, a modified plug shape is anticipated. FIGS. 10 and 11 show two possible alternative embodiments. These are examples of box-shaped 24 or smooth 25 shape modifications that can be applied to the trailing section of the plug body 22 in order to achieve whatever flow dispersion is desired. It should be obvious that these are just two examples of the many alternate embodiments which the current invention anticipates, including, but not limited to: transverse or helical vanes, winglets, mixing nozzles for a secondary fluid, etc. Virtually any shape can be crafted onto the trailing section of the plug, so long as its vertically projected planform does not violate the projected perimeter of the cutout of the seal diaphragm 17.

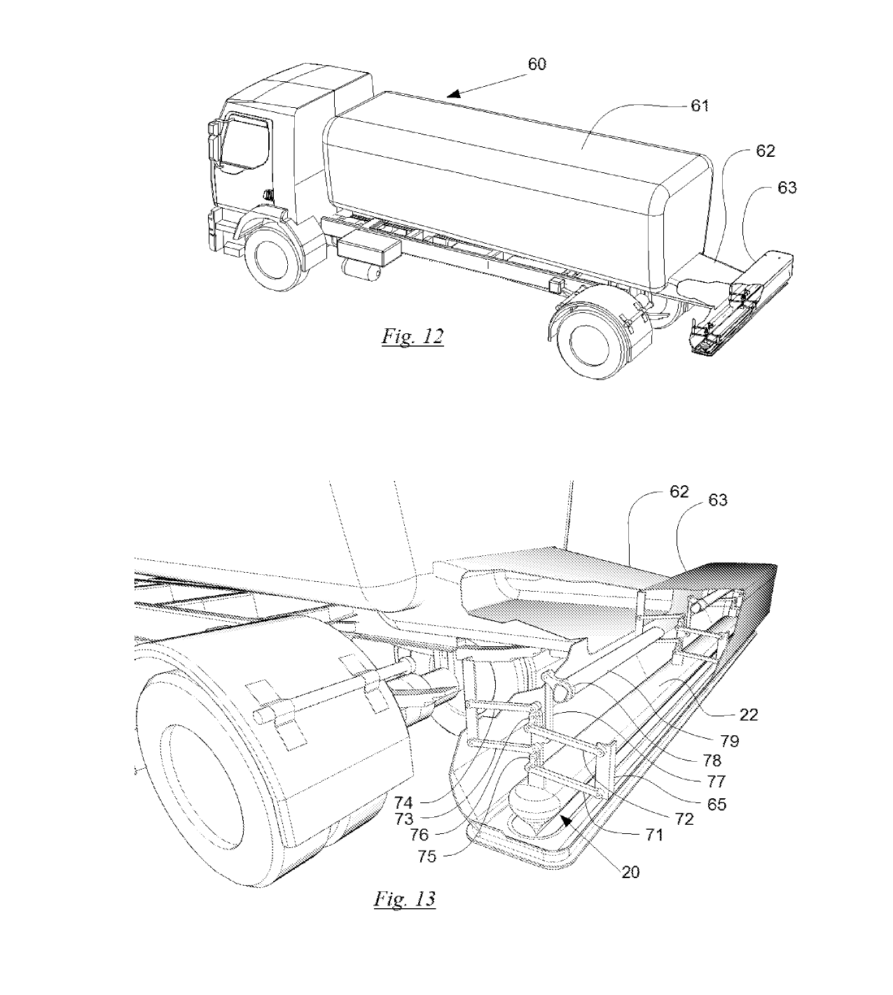

### FIGS. 12 through 16

### Alternate Embodiment

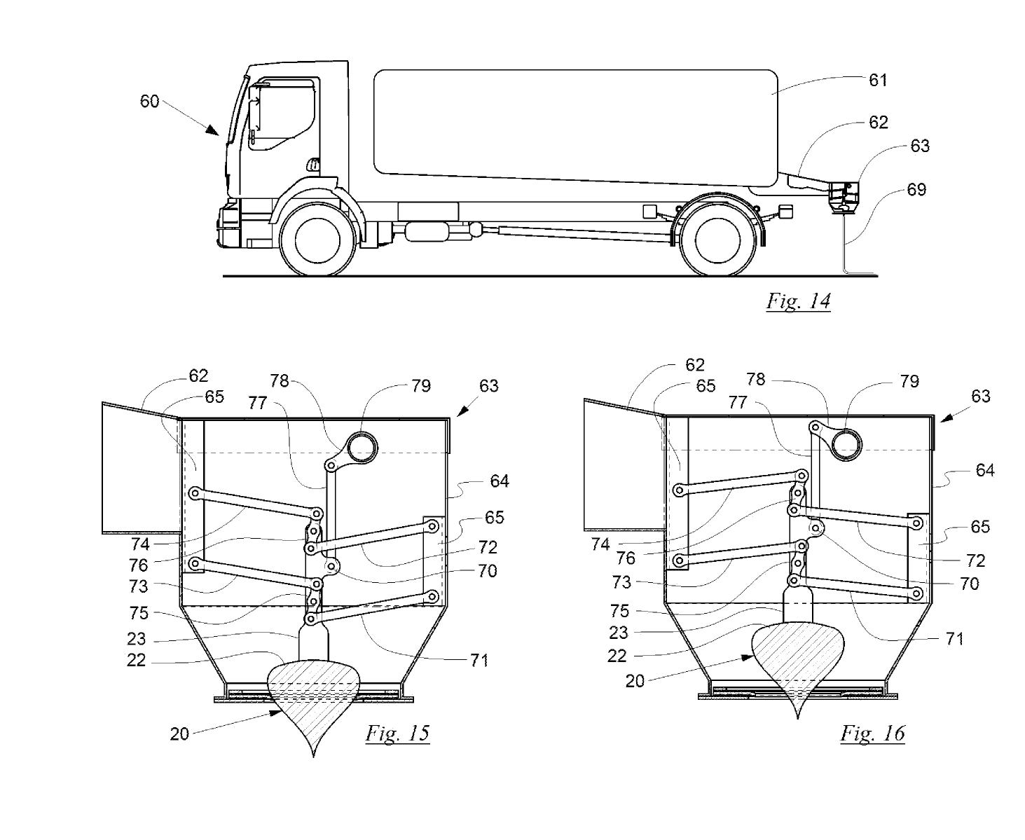

FIGS. 12, 13, 14, 15 and 16 show an embodiment of the present invention as applied to the back of a vehicle for the purpose of spreading a liquid working fluid onto a roadway or other surface traversable by said vehicle. Here there is shown a vehicle 60 having a main storage tank 61 for storing a large volume of the working fluid, a feeder section 62 through which the working fluid is transferred into the header tank 64 of the dispensing device 63. In this embodiment the dispensing device 63 is transversely mounted, so that its lengthwise dimension is parallel to the lateral axis of the vehicle 60, for the purpose of dispensing a sheet of the working fluid 69 which spreads orthogonally to the travel direction of the vehicle 60, as shown in FIG. 14. Shown here is a single plug embodiment. It should be noted that in the case that a wider dispensing swath is desired, either the header tank 64 and plug assembly 20 could be made longer (wider on the vehicle), or multiple plug assemblies 20 and/or header tanks 64 could be assembled end-to-end in order to achieve said objective.

Referring now to FIGS. 13, 15 and 16, one embodiment of a linkage system for actuation of the plug assembly 20 is disclosed. This embodiment utilizes the well known Watt linkage to accomplish approximately vertically constrained movement of the plug assembly 20. FIG. 15 shows the invention in the closed position, in which no fluid is allowed to flow. FIGS. 13 and 16 show the plug assembly 20 in the open position

The invention of FIGS. 12 through 16 further comprises a torque shaft 79 (shown in cut away form in FIG. 13) having lift crank arms 78 fixably attached thereto, and extending out at least one end of the header tank 64 through a sealed bearing or bushing, and being supported as necessary at any number of points along its length. A lift link 77 is rotatably attached at its upper end to the lift crank arm 78, its lower end being rotatably attached at attachment point 70 to the actuation bracket 23 also discussed in FIGS. 1 and 2.

To begin dispensing the working fluid, a clockwise rotation is applied to the torque shaft 79, which can be effected by any of a variety of means commonly known in the art. Since the lift crank arm 78 is fixably attached to torque shaft 79, said rotation results in an upward motion of lift link 77, which in turn lifts the plug assembly 20 vertically out of its sealed position, permitting exit flow of the working fluid.

Referring to FIGS. 13, 15 and 16, the details of the Watt linkage are as follows: Upper and lower parallel links 71, 72, 73, and 74 are rotatably attached to the header tank 64 walls via stationary mounts 65, which are fixably attached to the header tank 64 walls. Said parallel links each attach rotatably to their respective middle Watt links 75 or 76. Said middle Watt links are each rotatably attached to the actuation arm 23 at their respective middle points. This mechanical arrangement is well known in the art as a common means of constraining mechanical motion to a nearly linear path. As the plug assembly 20 travels vertically, the middle Watt links 75 and 76 travel with it, rotating slightly in order to allow the arc of travel of the moving ends of the parallel links 71, 72, 73, and 74.

### Other Alternate Embodiments

There are a number of design variations that are easily anticipated by the present invention, including, but not limited to:
(a) use of a single mechanical link rigidly attached to the actuation bracket 23, said link extending a lateral distance to a rotatable attachment trunnion, said lateral distance great enough to provide near vertical, yet semicircular actuation of the plug assembly 20;
(b) addition to the linkage mechanism, a means of tilting the plug body 22 or plug assembly 20 along its longitudinal axis, for the purpose of deflecting the direction of outflow to the left or right as viewed in FIGS. 3 through 6, 15, and 16;
(c) addition to the linkage mechanism, a means of lifting one end of the plug body 22 or plug assembly 20 higher or lower than its opposite end, for the purpose of biasing or tapering the distribution of working fluid outflow along its longitudinal axis;
(d) installing the invention in any spatial orientation such that the working fluid outflow proceeds in a direction other than vertically downward;
(e) employment of any of a variety of approximately inverted teardrop shapes for the cross section of the plug;
(f) employment of any of a variety of sealing means in place of the seal diaphragm 17 shown in FIGS. 1 through 6, including o-ring, complementary machined surfaces, etc.;
(g) use of a seal planform of any particular shape, the only requirement being that the seal planform must be of similar shape to the horizontal cross section of the plug at the elevation on the plug at which the two members meet to form pinch point 43 of FIG. 3.

### CONCLUSION, RAMIFICATIONS, AND SCOPE

Accordingly, the reader will see that the fluid dispensing device of this invention provides a more laminar outflow from a hopper or header tank plenum, and that there are many cases in various industries where this is a desirable quality, as it allows greater precision and accuracy in evenly distributing a working fluid onto a target surface.

In broad embodiment, the present invention is a means of regulating the outflow of fluid from the bottom of a tank or reservoir. Said fluid may be a liquid, a slurry such as those commonly used in fire fighting applications, or a powdered or granulated solid which exhibits quasi-fluid flow properties. In the case of a liquid or a slurry, the resultant downward exit flow is of a more laminar character than that attainable by one or more quasi-planar doors opening either upward (into the tank) or downward. The current invention may be incorporated as a component of new tank systems, or implemented as a retrofit to existing tank systems.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods within the scope and spirit of the invention.

### INDUSTRIAL APPLICABILITY

The present invention finds application in, but is not limited to, the fields of agriculture, construction, roadway maintenance, paper or film processing, material handling, and aerial fire fighting.

### REFERENCE SIGNS LIST

10 tank assembly
15 tank shell
16 clamp bezel
17 seal diaphragm
18 lower floor plate
20 plug assembly
22 plug body
23 actuation bracket
24 box shape modification (to trailing edge 28)
25 smooth shape modification (to trailing edge 28)
28 trailing edge (of plug body 22)
41 lateral clearance (between plug and tank shell)
42 clearance aperture (for fluid flow)
43 pinch point (fluid shut-off)
51 velocity profile (of working fluid)
52 velocity profile (of working fluid)
53 downstream velocity profile (of working fluid)
55 bulk velocity vector (of working fluid)
60 vehicle
61 main storage tank
62 feeder section
63 dispensing device
64 header tank
65 stationary mount
69 sheet of working fluid
70 attachment point
71 lower parallel link
72 upper parallel link
73 lower parallel link
74 upper parallel link
75 middle Watt link
76 middle Watt link
77 lift link
78 lift crank arm
79 torque shaft

### CITATION LIST

### Patent Literature

| | | | |
|---|---|---|---|
| U.S. Pat. No. 1,863,968 | C. W. Dearing | Gravel Spreader | Jun. 21, 1932 |
| U.S. Pat. No. 4,387,855 | Niels J. O. Nielsen | Salt and/or gravel spreader | Jun. 14, 1983 |
| U.S. Pat. No. 4,052,003 | Ronald W. Steffen | Liquid spreader control system | Oct. 4, 1977 |
| U.S. Pat. No. 4,350,293 | Maurice C. J. Lestradet | Vehicle equipped with a liquid | Sep. 21, 1982 |
| | | spreader device | |
| U.S. Pat. No. 7,211,297 | Wayne A. Damrau | Apparatus for decreasing skip | May 1, 2007 |
| | | coating on a paper web | |
| U.S. Pat. No. 5,735,957 | Rex A. Becker, Alfred C. | Dual chamber film applicator with | Apr. 7, 1998 |
| | Li, James R. Burns | in-pond overflow | |
| U.S. Pat. No. 898,689 | FEED L. SAWYER | HOPPER-VALVE | Sep. 15, 1908 |
| U.S. Pat. No. 3,405,656 | G. B. DOREY | OPPOSITELY SWINGING | Oct. 15, 1968 |
| | | RAILWAY HOPPER VALVES | |
| U.S. Pat. No. 7,165,627 | Michael David Hutter, et | Portable airborne firefighting and | Jan. 23, 2007 |
| | al. | sensing system | |
| U.S. Pat. No. 3,901,467 | John Knox Hawkshaw | AIRCRAFT FIRE BOMBING | Aug. 26, 1975 |
| | | SYSTEM | |
| U.S. Pat. No. 4,671,472 | John K. Hawkshaw | Fire bombing and fire bombers | Jun. 9, 1987 |
| U.S. Pat. No. 4,936,389 | Alan B. MacDonald, | Fluid dispenser for an aircraft | Jun. 26, 1990 |
| | Lawrence J. Neuwirth | | |

What is claimed is:

1. A fluid dispensing device for applying a working fluid onto a target surface, comprising:
(a) an elongated plenum region for gathering and settling of the working fluid prior to and during dispensing of said working fluid, comprising:
(1) a longitudinal side wall located an arbitrary distance from said plenum's longitudinal center line;
(2) an opposite longitudinal side wall located an arbitrary distance opposite the plenum center line from the aforementioned longitudinal side wall;
(3) end walls adjoining the ends of said side walls to form an enclosed volume capable of containing the working fluid;
(4) a floor adjoining the four said side walls at said floor's perimeter;
(b) an exit aperture in said floor of said plenum for passage of the working fluid during dispensing;
(c) an elongated plug of roughly inverted teardrop cross sectional shape, having a complementary horizontal cross section to said aperture, for shutting off the outflow of the working fluid;
(d) an actuation means for moving said plug in the direction contrary to the flow of the working fluid to allow the working fluid to exit said plenum region for the purpose of dispensing said working fluid;
whereby the working fluid may be controllably dispensed by varying the displacement of said plug, and whereby a largely laminar outflow of the working fluid may be produced at any given plug displacement and, hence, any given flow rate.

2. The device of claim 1 in which said elongated plug is of circular cross sectional shape.

3. The device of claim 1 in which said elongated plug is of trapezoidal cross sectional shape.

4. The device of claim 1 in which the working fluid is a liquid of any given viscosity.

5. The device of claim 1 in which the working fluid is a slurry mixture of a liquid and particulate solid.

6. The device of claim 1 in which the working fluid is a powdered, pelletized or granulated solid substance exhibiting fluid-like bulk flow characteristics.

7. The device of claim 1 in which the position of said plug is actively effected automatically via a mechanical means, whereby a constant density of fluid is delivered to the target surface.

8. The device of claim 1 in which the position of said plug is actively effected automatically via an electronic means, whereby a constant density of fluid is delivered to the target surface.

9. The device of claim 1 in which said fluid dispensing device is attached to a moving vehicle, its longitudinal axis being perpendicular to said vehicle's direction of travel, whereby a sheet of fluid may be applied to the surface upon which said vehicle traverses.

10. The device of claim 1 in which said fluid dispensing device is attached to a moving vehicle, its longitudinal axis being parallel to said vehicle's direction of travel, whereby a sheet of fluid may be applied to the surface upon which said vehicle traverses.

11. The device of claim 1 in which said fluid dispensing device is attached to a fixed-wing aircraft, its longitudinal axis being parallel to said aircraft's direction of travel, whereby a sheet of fluid may be dispensed from said aircraft in a concentrated manner.

12. The device of claim 1 in which said fluid dispensing device is attached to a rotary-wing aircraft, whereby a sheet of fluid may be dispensed from said aircraft in a concentrated manner.

13. The device of claim 1 in which said actuation means of the plug is accomplished by a rotary crank mechanism, the plug's linear motion being constrained by a plurality of Watt linkages distributed along its longitudinal axis.

14. The device of claim 1 in which said actuation means of the plug is accomplished by one or more direct hydraulic or electromechanical actuators moving the plug in a linear path.

15. The device of claim 1 in which said actuation means of the plug is accomplished by a single-axis rotary embodiment wherein the plug traverses a semi-circular arc.

16. The device of claim 1 in which said plenum region is closed to atmospheric pressure, and thus is pressurized by pump or other pressure source, such that spatial orientation of the plenum and overall embodiment is not constrained to the vertical.

17. The device of claim 1 wherein the general spatial orientation is other than vertical, in which case the driving potential for fluid flow is one other than gravitational forces alone.

18. A fluid dispensing device for an aircraft having a longitudinal axis comprising a fluid container on said aircraft, a floor of said fluid container having a fluid exit aperture of complementary shape to a plug for the purpose of sealing said container shut, said plug being of roughly inverted teardrop cross section, said plug being actuated upward vertically to allow fluid to exit said fluid container.

19. The device of claim 18 in which said fluid flow rate is dynamically controlled by active vertical positioning of said plug in reaction to flight velocity, instantaneous g-loads, and head pressure of the fluid load contained by said fluid container.

20. A stationary fluid dispensing device for dispensing a constant or controlled rate of flow of a working fluid onto a moving substrate comprising a header tank, the floor of said header tank having a fluid exit aperture of complementary shape to a plug for the purpose of sealing said header tank shut, said plug being of roughly inverted teardrop cross section, said plug being actuated upward vertically to allow fluid to exit said header tank.

21. The device of claim 20 in which said fluid flow rate is dynamically controlled by active vertical positioning of said plug in reaction to the travel velocity of the target substrate, and header tank head pressure.
